(19) United States
(12) Patent Application Publication
(10) Pub. No.: US 2007/0177873 A1
(43) Pub. Date: Aug. 2, 2007

(54) Hybrid passive optical network

(75) Inventors: Yoo-Jeong Hyun, Seongnam-si (KR); Dae-Kwang Jung, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/652,335

(22) Filed: Jan. 11, 2007

(30) Foreign Application Priority Data
Jan. 27, 2006 (KR) 2006-9045

(51) Int. Cl. H04J 14/00

(52) U.S. Cl. 398/72

(57) ABSTRACT

Disclosed is a hybrid PON including: a central office, remote terminal and a plurality of optical network units arranged in groups, the central office for outputting downstream optical signals, the remote node for wavelength-division-demultiplexing the downstream optical signals input from the central office, splitting the demultiplexed downstream optical signals, respectively, to generate multiple downstream optical signals, outputting the multiple downstream optical signals to optical network units of a corresponding group, generating corresponding upstream optical signals modulated into upstream subcarriers of a corresponding group input from the optical network units of the group, and outputting the generated upstream optical signals to the central office, and the optical network units for obtaining downstream subcarriers of a corresponding group from corresponding downstream optical signals input from the remote node, obtaining corresponding downstream subcarriers by filtering the downstream subcarriers of the group, and outputting corresponding upstream subcarriers to the remote node.

### CLAIM OF PRIORITY

This application claims the benefit of the earlier filing date, pursuant to 35 USC 119, to that patent application entitled “Hybrid PON” filed in the Korean Intellectual Property Office on Jan. 27, 2006 and assigned Serial No. 2006-9045, the contents of which are hereby incorporated by reference.

### BACKGROUND OF THE INVENTION

1. Field of the Invention

The present invention relates to a Passive Optical Network (PON), and more particularly to a hybrid PON using Wavelength Division Multiplexing (WDM)/Subcarrier Multiplexing (SCM).

2. Description of the Related Art

Much interest has been focused on a WDM-PON as the next subscriber network for providing the future broadband communication service. A WDM-PON transmits multiple optical signals with different wavelengths through a single optical line in a wavelength range of 1300 to 1600 nm. Recently, as subscribers have required a broadband service including digital TV (HDTV), remote education and a picture phone, the bandwidth necessary per subscriber has been increasing. Based on a determination that a data rate per subscriber will reach several hundreds of Mb/s, much interest has been focused on a WDM-PON allocating a separate wavelength to each subscriber. A WDM-PON is advantageous in that it can not only provide a wide bandwidth of several Gb/s, but can also ensure excellent security and provide communication protocol independence. However, a WDM-PON has not yet been commercialized because it is still too expensive. Thus, research into a low-priced WDM-PON has been actively conducted.

In an SCM scheme, a carrier is modulated into data signals, such as digital image signals, analog image signals and Internet signals (hereinafter, a modulated carrier referred to as a subcarrier), and optical signals generated by modulating light of a predetermined wavelength by using the subcarrier are transmitted. In a TDM/SCM PON, multiple Optical Network Units (ONUs) transmit upstream optical signals of the same wavelength to a Central Office (CO) through a Remote Node (RN). Herein, the ONU refers to an apparatus provided to a subscriber. In such an SCM scheme, a large amount of image and data services can be provided because it is possible to use the wide bandwidth of an optical fiber through multiple subcarriers. Further, it is possible to provide a service to many more subscribers by using an optical amplifier and a Power Splitter (PS), and to easily provide various types of services through subcarriers. Further, since all ONUs generally transmit upstream optical signals by using a low-priced Fabry-Perot laser tolerant to Optical Beat Interference (OBI), it is easy to manage wavelengths in upstream and downstream transmission.

However, since it is necessary to transmit many subcarriers while maintaining a high Signal-to-Noise Ratio (SNR) for a large amount of image and data services, a Central Office must modulate downstream optical signals by using an expensive optical modulator with superior linearity, and must transmit high-power downstream optical signals by using an optical amplifier so that optical receivers provided in each ONU can receive the high-power downstream optical signals. Further, since all ONUs must share and use a single wavelength for downstream transmission, a CO divides a time domain (cycle) for downstream transmission, allocates the divided time domains to each ONU, and transmits corresponding downstream optical signals during the time domains (time slots) allocated to said each ONU. Therefore, the capacity of data transmitted to each ONU is restricted. Further, since all ONUs must share and use a single wavelength for upstream transmission, a CO divides a cycle for upstream transmission, allocates the divided cycles to each ONU, and each ONU transmits corresponding upstream optical signals during the time slots allocated to each ONU. Therefore, the capacity of data transmitted by each ONU is restricted. That is, each ONU cannot transmit upstream optical signals during time slots other than the allocated ones.

Recently, a hybrid PON using a WDM scheme and an SCM scheme has attracted public attention. In a hybrid WDM/SCM PON, an Remote Node splits each downstream optical signal, which has been demultiplexed through a (1×N) wavelength division multiplexer, into multiple downstream optical signals by using a (1×M) Power Splitter. Herein, a single downstream optical signal has been modulated into M subcarriers. As a result, M subcarriers can be obtained from N downstream optical signals, respectively, so (N×M) subscribers can be accommodated. Thus, compared to a conventional WDM PON, the hybrid PON is expected to reduce the cost per subscriber.

FIG. 1 is a block diagram illustrating a typical hybrid WDM/SCM PON. The hybrid PON 100 includes a CO 110, an RN 150 and and a plurality of ONUs (190-1-1) to (190-N-M) organized into a plurality of groups of ONUs (190-1) to (190-N).

The CO 110 includes first to N^{th} optical transceivers (TRXs) (120-1-120-N), and a first wavelength division multiplexer 130.

The NTRXs (120-1-120-N) each have the same construction, which are connected to first to N^{th} Demultiplexing Ports (DMPs) of the first wavelength division multiplexer 130 in a one-to-one fashion. The NTRXs (120-1-120-N) output N downstream optical signals, respectively, and receive first to N^{th} upstream optical signals, respectively. The N downstream optical signals have wavelengths λ₁ to λ_{N}, one wavelength being associated with a corresponding one of the N groups of ONUs. Each of the downstream optical signals is further modulated into M downstream subcarriers, each subcarrier associated with a corresponding with one of the ONUs with the corresponding group. The M downstream subcarriers have frequencies f₁ to f_{M}, respectively, which are modulated into M downstream data signals. Both the downstream subcarriers and the downstream data signals are electrical signals. The N upstream optical signals have wavelengths λ_{(N+1)} to λ_{2N}; each wavelength corresponding to one of the ONU groups. Each of the upstream optical signals is further modulated into M upstream subcarriers; each subcarrier associated with one of the ONUs in the corresponding group. The M upstream subcarriers have frequencies f₁-f_{M}, respectively, which have been modulated into M upstream data signals. Both the upstream subcarriers and the upstream data signals are electrical signals.

FIG. 1 illustrates in further detail, with reference to N^{th} TRX (120-N), a block diagram of a conventional transceiver. The description of the N^{th} TRX (120-N) provided herein is typical of each of the remaining transceivers, and is thus applicable to each of the remaining tranceivers 120-1 through 120-(N-1).

The N^{th} TRX (120-N) includes a Downstream Light Source (DLS) (122-N), a upstream optical receiver (URX) (124-N) and an Optical Coupler (CP) (126-N).

The N^{th} DLS (122-N) generates a downstream optical signal of an wavelength (λ_{N}) and outputs the downstream optical signal to the associated CP (126-N). The downstream optical signal has been modulated into M downstream subcarriers that have been modulated into downstream data signals associated the N^{th} group of ONUs.

The URX (124-N) receives an upstream optical signal from CP (126-N), and obtains upstream subcarriers and upstream data signals corresponding to the ONUs associated with the N^{th} group of ONUs (190-N).

CP (126-N) has a first port connected to the N^{th} port of DMP of the first wavelength division multiplexer 130, a second port connected to the URX (124-N), and a third port connected to the DLS (122-N). The CP (126-N) outputs the N^{th} upstream optical signal, received at the first port, to the second port, and outputs the N^{th} downstream optical signal, received at the third port, to the first port.

The first wavelength division multiplexer 130 has a Multiplexing Port (MP) and first to N^{th} DMPs. The MP is connected to a feeder fiber 140 and the first to N^{th} DMPs are connected to the first to N^{th} TRXs (120-1) to (120-N) in a one-to-one fashion. The first wavelength division multiplexer 130 wavelength-division-demultiplexes the N upstream optical signals received at port MP, and outputs the demultiplexed upstream optical signals to the corresponding DMPs in a one-to-one fashion. Further, the first wavelength division multiplexer 130 wavelength-division-multiplexes the N downstream optical signals the received at the N DMPs, and outputs the multiplexed downstream optical signals to the MP.

The RN 150 is connected to the CO 110 through the feeder fiber 140, which is connected to the ONUs (190-1-1) to (190-N-M) through distribution fibers (180-1-1) to (180-N-M) of the N groups of ONUs (180-1) to (180-N). The distribution fibers in each group are constructed by M distribution fibers. The RN 150 includes a second wavelength division multiplexer 160 and first to N^{th} optical PSs (170-1) to (170-N).

The second wavelength division multiplexer 160 has an MP (multiplexing port) and N DMPs. The MP is connected to the feeder fiber 140 and the N DMPs are connected to corresponding optical PSs (170-1) to (170-N) in a one-to-one fashion. The second wavelength division multiplexer 160 wavelength-division-demultiplexes the N downstream optical signals received at port MP, and outputs the demultiplexed upstream optical signals to the corresponding DMPs in a one-to-one fashion. Further, the second wavelength division multiplexer 160 wavelength-division-multiplexes the N upstream optical signals received at a corresponding DMP, and outputs the multiplexed downstream optical signals to the MP.

The optical PSs (170-1) to (170-N) are connected to the corresponding DMPs of the second wavelength division multiplexer 160 in a one-to-one fashion.

With reference to optical splitter 170-N, which is typical of each of the remaining splitters, optical PS (170-N) has an Upstream Port (UP) and M Downstream Ports (DPs). The UP of splitter 170-N is connected to the N^{th} DMP of the second wavelength division multiplexer 160, and M DPs are\connected to associated distribution fibers (190-N-1) to (190-N-M) of the N^{th} group (190-N) in a one-to-one fashion. The N^{th} optical PS (170-N) splits the received downstream optical signal received at UP to generate M optical signals, and outputs the M opticala corresponding one of the DPs. The N^{th} optical PS (170-N) further combines M upstream optical signals input to the M DPs, and outputs the combined upstream optical signals to the UP.

The groups of ONUs (190-1)-(190-N) and ONUs (190-1-1 )-(190-N-M) each have the same construction, Hence, a description of one group of ONUs and one ONU is applicable to each of the remaining ones. Groups of ONUs (190) are connected to corresponding PSs (170) through fibers (180). Each fiber 180 connects M ONUs in an associated group through distribution fibers (180-x-1 through 180-x-N) in a one-to-one fashion, where x represents a particular group.

With reference to the M^{th} ONU (190-N-M) of the N^{th} group (190-N), this ONU includes a frequency Modulator (MOD) (191-N-M, an Upstream Light Source, ULS (192-N-M), an downstream optical receiver (DRX) (193-N-M), a Bandpass Filter (BPF) (194-N-M) and a CP (195-N-M).

The MOD (191-N-M) generates and outputs a subcarrier with a frequency (fₘ), which is modulated into an M^{th} upstream data signal (D_{N-M}).

The ULS (192-N-M) generates and outputs an upstream data signal which is modulated into an M^{th} subcarrier on a (2N)^{th} wavelength.

The DRX (193-N-M) receives a downstream optical signal from the CP (195-N-M), and obtains associated downstream subcarriers.

The BPF (194-N-M) receives the downstream subcarriers and outputs a downstream subcarrier obtained by filtering the downstream subcarriers. The remaining (i.e., first to (M-1)^{th}) downstream subcarriers are removed by the M^{th} BPF (194-N-M).

The CP (195-N-M) has a first port connected to the associated distribution fiber (180-N-M) of the associated group (180-N), a second port connected to the DRX (193-N-M), and a third port connected to the ULS (192-N-M). The M^{th} CP (195-N-M) outputs the N^{th} downstream optical signal, which is received at the first port, to the second port, and outputs the N^{th} upstream optical signal, which is received at the third port, to the first port.

However, the WDM/SCM hybrid PON 100 as described above has the following problems.

First, the hybrid PON 100 can increase the number of subscribers by M times, as compared to a conventional WDM PON, but each of the ONUs (190-1-1) to (190-N-M) must have a separate ULS. Therefore, the number of ULSs increases by M times, which results in an increase in the cost required to construct an entire optical subscriber network.

Second, when upstream optical signals output from different optical network devices of the same group are simultaneously input to each URX included in the CO 110, the entire performance of an optical subscriber network may greatly deteriorate due to an Optical Beat Interference (OBI). The OBI occurs when two or more of lasers are operating simultaneously and components of their optical spectra too close in wavelength, wherein these components can beat at a receiver and generate noise. Herein, it is assumed that at least one of the upstream optical signals has a wavelength error. That is, a photodiode used as the URX has square-law photo-detection property which may cause an OBI. Since optical current output from the photodiode by optical signal input is proportional to optical power, and the optical power is expressed by the square of an optical field, when upstream optical signals with different wavelengths of the same group are input to the photodiode, an OBI may occur at a frequency corresponding to the difference among the wavelengths.

Equations 1 and 2 are given on an assumption that first and second optical signals with different wavelengths are simultaneously input to a photodiode.

$$\begin{matrix}\begin{matrix}i ( t ) = R \cdot l ( t ) \\ = R \cdot L \{ {ɛ}^{2} ( t ) \}\end{matrix} & Equation 1 \\ \begin{matrix}l ( t ) = {l}_{1} ( t ) + {l}_{2} ( t ) + 2 \sqrt{{l}_{1} ( t ) + {l}_{2} ( t )} \cdot cos \\ [ ( {ω}_{01} - {ω}_{02} ) t + {φ}_{1} ( t ) - {φ}_{2} ( t ) ] \\ = {l}_{1} ( t ) + {l}_{2} ( t ) + {l}_{x} ( t )\end{matrix} & Equation 2\end{matrix}$$

where t denotes time,
   i(t) denotes optical current,
   R denotes the degree of response of a photodiode,
   l(t) denotes optical power,
   ε(t) denotes optical field,
   L{ε²(t)} denotes a function using ε(t) as a replacement variable for l(t), l₁(t) and l₂(t) denote power of the first and second optical signals,
   Iₓ(t) denotes power of an OBI,
   ω₀₁ and ω₀₂ denote frequencies of the first and second optical signals, and
   φ₁ and φ₂ denote frequencies of the first and second optical signals.

The OBI has been recognized as an important issue in a WDM/SCM hybrid PON, together with the cost required to construct an entire network.

### SUMMARY OF THE INVENTION

Accordingly, the present invention has been made to solve the above-mentioned problems occurring in the prior art and provides additional advantages, by providing a low-cost WDM/SCM hybrid PON capable of minimizing an OBI.

In accordance with one aspect of the present invention, there is provided a hybrid Passive Optical Network (PON) including a central office, a remote terminal and a plurality of optical network units arranged in a plurality of optical network unit groups, the central office for outputting downstream optical signals, the remote node for wavelength-division-demultiplexing the downstream optical signals input from the central office, splitting the demultiplexed downstream optical signals, respectively, to generate multiple downstream optical signals, outputting the multiple downstream optical signals to optical network units of a corresponding group, generating corresponding upstream optical signals modulated into upstream subcarriers of a corresponding group input from the optical network units of the group, and outputting the generated upstream optical signals to the central office, and the optical network units for obtaining downstream subcarriers of a corresponding group from corresponding downstream optical signals input from the remote node, obtaining corresponding downstream subcarriers by filtering the downstream subcarriers of the group, and outputting corresponding upstream subcarriers to the remote node.

### BRIEF DESCRIPTION OF THE DRAWINGS

The above features and advantages of the present invention will be more apparent from the following detailed description taken in conjunction with the accompanying drawings, in which:

FIG. 1 is a block diagram illustrating a typical WDM/SCM hybrid PON;

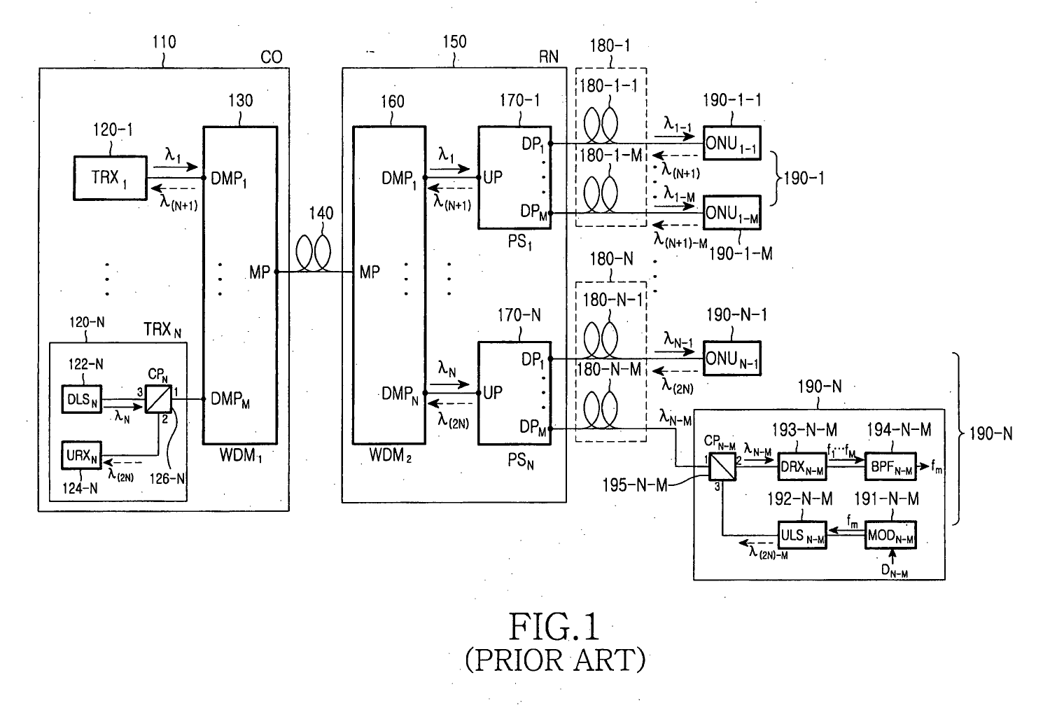

FIG. 2 is a block diagram illustrating a WDM/SCM hybrid PON according to a preferred embodiment of the present invention; and

FIG. 3 is a block diagram illustrating the detailed construction of the CO illustrated in FIG. 2.

### DETAILED DESCRIPTION

An exemplary embodiment of the present invention will be described in detail herein below with reference to the accompanying drawings. For the purposes of clarity and simplicity, a detailed description of known functions and configurations incorporated herein will be omitted as it may obscure the subject matter of the present invention.

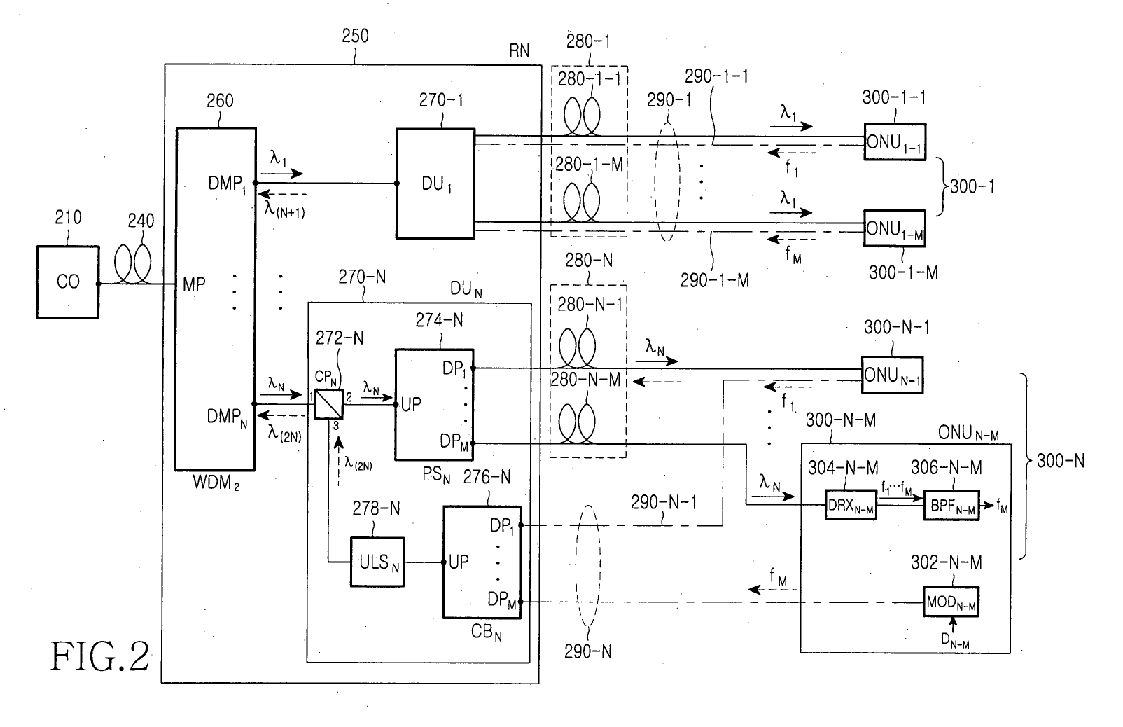

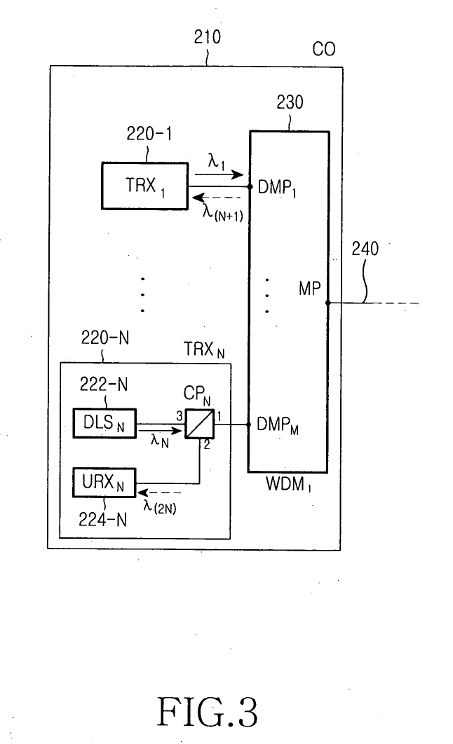

FIG. 2 is a block diagram illustrating a WDM/SCM hybrid PON according to a preferred embodiment of the present invention, and FIG. 3 is a block diagram illustrating the detailed construction of the CO illustrated in FIG. 2. The hybrid PON 200 includes a CO 210, an RN 250 and ONUs (300-1-1) to (300-N-M) in N groups (300-1) to (300-N).

The CO 210 includes N optical transceivers (TRXs) (220-1) to (220-N), and a first wavelength division multiplexer 230.

Each N TRXs (220-1) to (220-N) have the same construction, which are connected to corresponding Demultiplexing Ports (DMPs) of the first wavelength division multiplexer 230 in a one-to-one fashion. The NTRXs (220-1) to (220-N) each output a downstream optical signal and receive corresponding upstream optical signals, The downstream optical signals are represented as wavelengths λ₁ to λ_{N}, and each of the downstream optical signals is modulated into M downstream subcarriers constituting a corresponding group. The M downstream subcarriers have frequencies represented as f₁ to f_{M}. Both the downstream subcarriers and the downstream data signals are electrical signals.

The upstream optical signals have (N+1)^{th} to (2N)^{th} wavelengths λ_{(N+1)} to λ_{2N}, and each of the upstream optical signals is modulated into M upstream subcarriers constituting a corresponding group. The M upstream subcarriers have frequencies which are modulated into M upstream data signals constituting a corresponding group, respectively. Both the upstream subcarriers and the upstream data signals are electrical signals.

As discussed previously, the transceivers are identically constructed and thus only a single one need be discussed in detail to provide one skilled in the art sufficient information to practice the invention discloses. With reference to FIG. 3, the N^{th} TRX (220-N), this transceiver includes an N^{th} Downstream Light Source (DLS) (222-N), an N^{th} upstream optical receiver (URX) (224-N) and an N^{th} Optical Coupler (CP) (226-N). All of the M frequencies may be radio frequencies.

The N^{th} DLS (222-N) generates an downstream optical signal of an N^{th} wavelength and outputs the downstream optical signal to the N^{th} CP (226-N). The downstream optical signal is modulated into downstream subcarriers of a corresponding group, and these downstream subcarriers are modulated into downstream data signals of the group, respectively. In one aspect, it is possible to use a Febry-Perot laser or a Distribute feedback Laser Diode (DFB-LD) as the N^{th} DLS (222-N).

The N^{th} URX (224-N) receives an upstream optical signal from the CP (226-N), and sequentially obtains upstream subcarriers and upstream data signals from the N^{th} upstream optical signal. The N^{th} URX (224-N) may use a combination of a photodiode for photoelectric conversion and a demultiplexer for frequency division demultiplexing.

The CP (226-N) has a first port connected to the N^{th} DMP of the first wavelength division multiplexer 230, a second port connected to the URX (224-N), and a third port connected to the DLS (222-N). The CP (226-N) outputs the N^{th} upstream optical signal, which is received at the first port, to the second port, and further outputs the downstream optical signal, which is input to the third port, to the first port.

The first wavelength division multiplexer 230 has a Multiplexing Port (MP) and N DMPs. The MP is connected to a feeder fiber 240 and the N DMPs are sequentially connected to the corresponding TRXs (220-1) to (220-N) in a one-to-one fashion. The first wavelength division multiplexer 230 wavelength-division-demultiplexes the N upstream optical signals input to the MP, and sequentially outputs the demultiplexed upstream optical signals to the first to N^{th} DMPs in a one-to-one fashion. Further, the first wavelength division multiplexer 230 wavelength-division-multiplexes the N downstream optical signals input to the corresponding DMP, and outputs the multiplexed downstream optical signals to the MP. Herein, it is possible to use a (1×N) Arrayed Waveguide Grating (AWG) as the first wavelength division multiplexer 230.

The RN 250 (see FIG. 2) is connected to the CO 210 through the feeder fiber 240, which is connected to the ONUs (300-1-1) to (300-N-M) of the N groups (300-1) to (300-N) through both distribution fibers (280-1-1) to (280-N-M) of the corresponding groups (280-1) to (280-N) and electrical lines (290-1-1) to (290-N-M) of the corresponding groups (290-1) to (290-N). The distribution fibers in each group are constructed by the first to M^{th} distribution fibers, and the electrical lines in each group are constructed by the first to M^{th} electrical lines. It is possible to use conventional coaxial cables as the electrical lines (290-1-1) to (290-N-M). The RN 250 includes a second wavelength division multiplexer 260 and N Distribution Units (DUs) (270-1) to (270-N).

The second wavelength division multiplexer 260 has an MP and N DMPs. The MP is connected to the feeder fiber 240 and the N DMPs are sequentially connected to a corresponding DUs (270-1) to (270-N) in a one-to-one fashion. The second wavelength division multiplexer 260 wavelength-division-demultiplexes the N downstream optical signals input to the MP, and sequentially outputs the demultiplexed upstream optical signals to an associated DMP in a one-to-one fashion. Further, the second wavelength division multiplexer 260 wavelength-division-multiplexes the N upstream optical signals input to the corresponding DMP, and outputs the multiplexed downstream optical signals to the MP.

The DUs (270-1) to (270-N) each have the same construction, which are sequentially connected to corresponding DMPs of the second wavelength division multiplexer 260 in a one-to-one fashion. The N^{th} DU (270-N) includes an N^{th} CP (272-N), an N^{th} PS (274-N), an N^{th} Frequency Combiner (CB) (276-N) and an N^{th} ULS (278-N).

The N^{th} CP (272-N) has a first port connected to the N^{th} DMP of the second wavelength division multiplexer 260, a second port connected to the N^{th} PS (274-N), and the third port connected to the N^{th} ULS (278-N). The N^{th} CP (272-N) outputs the N^{th} downstream optical signal, which is received at the first port, to the second port, and outputs the N^{th} upstream optical signal, which received at the third port, to the first port.

The N^{th} PS (274-N) has an Upstream Port (UP) and M Downstream Ports (DPs). The UP is connected to a port of CP (272-N), and the M DPs are sequentially connected to the distribution fibers (280-N-1) to (280-N-M) of the corresponding group (280-N) in a one-to-one fashion. The N^{th} PS (274-N) splits the a received downstream optical signal input to the UP to generate M number of N^{th} downstream optical signals, and outputs the M number of N^{th} downstream optical signals to a corresponding one of the M DPs.

The N^{th} CB (276-N) has a UP and M DPs. The UP is connected to the N^{th} ULS (278-N), and the first to M^{th} DPs are sequentially connected to the electrical lines (290-N-1) to (290-N-M) of the corresponding N^{th} group (290-N) in a one-to-one fashion. The N^{th} CB (276-N) combines the first to M^{th} upstream subcarriers input to the first to M^{th} DPs and outputs the combined upstream subcarriers to the UP.

The N^{th} ULS (278-N) is connected to the UP of the N^{th} CB (276-N) at one end thereof, and is connected to the third port of the N^{th} CP (272-N) at the other end thereof. The N^{th} ULS (278-N) generates the N^{th} upstream optical signal with an (2N)^{th} wavelength, which is modulated into the first to M^{th} upstream subcarriers, and outputs the N^{th} upstream optical signal to the N^{th} CP (272-N). It is possible to use a Fabry-Perot laser as the N^{th} ULS (278-N).

The ONUs (300-1-1) to (300-N-M) each have the same construction, and the connect of each of the ONUs in each group are also constructed the same. The ONUs in each group are sequentially connected to distribution fibers of a corresponding group in a one-to-one fashion, and are sequentially connected to electrical lines of the corresponding group in a one-to-one fashion. The M^{th} ONU (300-N-M) of the N^{th} group (300-N) includes an M^{th} MOD (302-N-M), an M^{th} downstream optical receiver (DRX) (304-N-M), and an M^{th} Bandpass Filter (BPF) (306-N-M).

The M^{th} MOD (302-N-M) is connected to the M^{th} electrical line (290-N)-M of the N^{th} group (290-N). The M^{th} MOD (302-N-M) generates an M^{th} subcarrier with an M^{th} frequency, which is modulated into an M^{th} upstream data signal, and outputs the M^{th} subcarrier to the M^{th} electrical line (290-N)-M.

The M^{th} DRX (304-N-M) is connected to the distribution fiber (280-N)-M of the N^{th} group (280-N) at one end thereof, and is connected to the M^{th} BPF (306-N-M) at the other end thereof. The M^{th} DRX (304-N-M) receives an N^{th} downstream optical signal from the distribution fiber (280-N-M) of the N^{th} group (280-N), and obtains downstream subcarriers of the N^{th} group from the N^{th} downstream optical signal. The M^{th} DRX (304-N-M) may use a combination of a photodiode for photoelectric conversion and a demultiplexer for frequency division demultiplexing.

The M^{th} BPF (306-N-M) receives the downstream subcarriers of the N^{th} group from the M^{th} DRX (304-N-M), and outputs an M^{th} downstream subcarrier obtained by filtering the downstream subcarriers of the N^{th} group. In this case, the first to (M-1)^{th} downstream subcarriers are removed by the M^{th} BPF (306-N-M), except for the M^{th} downstream subcarrier.

According to a WDM/SCM hybrid PON based on the present invention as described above, subcarriers generated by ONUs are transmitted to an RN through electrical lines, and the RN generates upstream optical signals modulated into the subcarriers, so that the required number of ULSs may be greatly reduced and thus the cost required to construct an entire optical subscriber network may also be greatly reduced. Further, one ULS is used for each upstream optical signal, so that it is possible to minimize OBI.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A hybrid Passive Optical Network (PON) comprising:
a central office for:
multiplexing a plurality of optical signals, each of which including at least one subchannel; and
outputting the multiplexed optical signals as a downstream optical signal and
a remote node for:
wavelength-division-demultiplexing the downstream optical signal received from the central office to generate a plurality of optical signals, each of the optical signals is associated with a group of optical network units,
outputting individual optical signals to the optical network units of the to group associated with a specific one of the optical signals,
receiving from each of optical network units electrical signals,
generating corresponding upstream optical signals modulated into upstream subcarriers of a corresponding group input from the optical network units of the group, and
outputting the generated upstream optical signals to the central office, and a plurality of optical network units receiving an associated optical signal for:
obtaining corresponding downstream subcarriers by filtering the downstream subcarriers of the group, and
outputting corresponding upstream subcarriers to the remote node.

2. The hybrid PON as claimed in claim 1, wherein the remote node is connected to each of the optical network units through optical fibers and electrical lines.

3. The hybrid PON as claimed in claim 2, wherein the electrical line uses a coaxial cable.

4. The hybrid PON as claimed in claim 2, wherein the upstream and downstream subcarriers have been modulated into corresponding data signals, respectively, and have radio frequencies.

5. The hybrid PON as claimed in claim 1, wherein the remote node comprises:
a wavelength division multiplexer for wavelength-division-demultiplexing the downstream optical signals input to a multiplexing port from the central office, and outputting the demultiplexed downstream optical signals to multiple demultiplexing ports; and
multiple distribution units connected to the demultiplexing ports of the wavelength division multiplexer in a one-to-one fashion,
wherein each of the distribution units comprises:
an optical power splitter for splitting received signal and outputting the split received signals to the optical network units of the corresponding group;
a frequency combiner for combining and outputting received upstream subcarriers of the corresponding group input from the optical network units of the group; and
an upstream light source for generating a corresponding upstream optical signals modulated by the combined upstream subcarriers input from the frequency combiner.

6. The hybrid PON as claimed in claim 1, wherein each of the optical network units comprises:
a downstream optical receiver for obtaining the downstream subcarriers of the corresponding group from the optical signal input from the remote node;
a bandpass filter for outputting the corresponding downstream subcarriers; and
a frequency modulator for modulating the corresponding upstream data signals.

7. A optical network bi-directional remote terminal comprising:
means for receiving a WDM downstream optical signal, each of the wavelengths contained therein having at least one downstream channel;
means for demultiplexing the received WDM signal and distributing individual wavelengths thereof to specific ones of a plurality of optical network units;
means for receiving electrical signals from the specific ones of the plurality of optical network units;
means for multiplexing the received electrical signals as subchannels onto a specific one of a plurality of upstream wavelengths; and
means for receiving and multiplexing the plurality of upstream wavelengths as a WDM upstream optical signal; and
means for outputting the WDM upstream optical signal.

8. The remote terminal as recited in claim 7, further comprising:
a plurality of fiber-optical cables for distributing the individual optical signals to each of the optical network units; and
a plurality of electrical lines for receiving the electrical signals from the optical network units.

9. The remote terminal as recited in claim 7, further comprising:
means for sequentially distributing the individual wavelengths to each of the associated optical network units.

10. A optical network unit comprising:
means for receiving an optical signal comprising a plurality of subchannel frequencies;
means for filtering and outputting a desired one of the plurality of subchannel frequencies; and
means for outputting an electrical signal at a known frequency.

11. The optical network unit as recited in claim 10, further comprising:
optical fiber means for receiving the optical signal; and
electrical transmission means for outputting the electrical signal.

12. The optical network unit as recited in claim 11, wherein the electrical transmission means is a coaxial cable.
